(19) United States
(12) Patent Application Publication
(10) Pub. No.: US 2024/0232777 A1
(43) Pub. Date: Jul. 11, 2024

(54) METHOD AND APPARATUS FOR SCREENING ENTERPRISES IN YANGTZE RIVER BASIN, ELECTRONIC DEVICE AND STORAGE MEDIUM

(71) Applicant: CHINESE RESEARCH ACADEMY OF ENVIRONMENTAL SCIENCES, Beijing (CN)

(72) Inventors: Haisheng LI, Beijing (CN); Hua JIANG, Beijing (CN); Jianglong CUI, Beijing (CN); Lieyu ZHANG, Beijing (CN); Yijun BAO, Beijing (CN); Guowen LI, Beijing (CN); Cao LIU, Beijing (CN); Wensi WANG, Beijing (CN); Xiaoguang LI, Beijing (CN); Jiaqian LI, Beijing (CN); Chen ZHAO, Beijing (CN); Caole LI, Beijing (CN); Wei LI; Xiaolin HOU, Beijing (CN)

(73) Assignee: CHINESE RESEARCH ACADEMY OF ENVIRONMENTAL SCIENCES, Beijing (CN)

(21) Appl. No.: 18/009,355

(22) PCT Filed: Oct. 25, 2022
(86) PCT No.: PCT/CN2022/127385

§ 371 Date: Dec. 9, 2022

(30) Foreign Application Priority Data
Aug. 26, 2021 (CN) 202110989218.4

(51) Int. Cl. G06Q 10/0639; G06F 16/33; G06F 40/289

(52) U.S. Cl. CPC G06Q 10/06393; G06F 16/3344; G06F 40/289

(57) ABSTRACT

A method and apparatus for screening enterprises in Yangtze River Basin, an electronic device and a storage medium are provided. The method includes: acquiring original enterprise data belonging to a preset industry category, and comparing the original enterprise data with screened local enterprise data to obtain common enterprise data of the original enterprise data and the local enterprise data; extracting a first text feature from a business scope of the common enterprise data, and extracting a second text feature from a business scope of each enterprise in the original enterprise data; and performing feature matching on the second text feature corresponding to each enterprise and the first text feature respectively, and when a matching result meets a preset condition, determining that the enterprise is a first target enterprise. An accuracy of enterprise screening can be improved.

### CROSS REFERENCE TO THE RELATED APPLICATIONS

This application is the national phase entry of International Application No. PCT/CN2022/127385, filed on Oct. 25, 2022, which is based upon and claims priority to Chinese Patent Application No. 202110989218.4, filed on Aug. 26, 2021, the entire contents of which are incorporated herein by reference.

### TECHNICAL FIELD

The present disclosure relates to the technical field of environmental protection, in particular to a method and apparatus for screening enterprises in Yangtze River Basin, an electronic device and a storage medium.

### BACKGROUND

In the Yangtze River Basin, total phosphorus pollution has exceeded COD (chemical oxygen demand) and ammonia nitrogen, and has become the primary pollutant in the whole basin. After the total phosphorus exceeds the standard, it will lead to eutrophication, foul smell and even red tide to the water body. Secondly, phosphorus can directly harm human skin, causing various skin inflammations, vomiting, diarrhea, headache and even poisoning. It can be seen that it is urgent to protect and restore the Yangtze River. Remediation of “three phosphorus” (i.e., phosphorite, phosphating factory and phosphogypsum reservoir) is one of the important contents of the Yangtze River protection and restoration battle.

The Yangtze River Basin spans three major economic zones in the east, middle and west of China. Yangtze River Economic Belt concentrates most of the phosphorus chemical production capacity in China, and finding out the number of “three phosphorus” enterprises in an all-round way is the basis for winning the battle of Yangtze River restoration. At present, the accuracy of “three phosphorus” enterprises obtained by environmental protection supervisors is low.

### SUMMARY

### (I) Technical Problems to be Solved

The technical problems to be solved by the present disclosure are that an accuracy of “three phosphorus” enterprises acquired by environmental protection supervisors is low.

### (II) Technical Solutions

In order to solve the above technical problems or at least partially solve the above technical problems, the present disclosure provides a method and apparatus for screening enterprises in Yangtze River Basin, an electronic device and a storage medium.

In a first aspect, the present disclosure provides a method for screening enterprises in Yangtze River Basin, including:
acquiring original enterprise data belonging to a preset industry category, and comparing the original enterprise data with screened local enterprise data to obtain common enterprise data of the original enterprise data and the local enterprise data;
extracting a first text feature from a business scope of the common enterprise data, and extracting a second text feature from a business scope of each enterprise in the original enterprise data; and
performing feature matching on the second text feature corresponding to each enterprise and the first text feature respectively, and when a matching result meets a preset condition, determining that the enterprise is a first target enterprise.

In an optional embodiment, after determining that the enterprise is the first target enterprise, the method further includes:
determining an activation degree of the first target enterprise and screening a second target enterprise from the first target enterprise based on the activation degree.

In an optional embodiment, the extracting the first text feature from the business scope of the common enterprise data, includes:
extracting at least one first target field from the business scope of the common enterprise data, and counting a word frequency of the at least one first target field; and
taking a mapping relationship between the first target field and the word frequency as the first text feature; and
the extracting the second text feature from the business scope of each enterprise in the original enterprise data, includes:
for each enterprise in the original enterprise data, extracting at least one second target field from a business scope of the enterprise; and
taking the second target field as the second text feature corresponding to the enterprise.

In an optional embodiment, the first target field and the second target field include a business mode field and a business content field.

In an optional embodiment, the performing feature matching on the second text feature corresponding to each enterprise and the first text feature respectively, and when the matching result meets the preset condition, determining that the enterprise is a first target enterprise, includes:
calculating a similarity between the second target field in the second text feature corresponding to each enterprise and each first target field in the first text feature;
for each second target field, determining the first target field having the similarity with the second target field greater than a preset similarity threshold as the first target field corresponding to the second target field;
taking a sum of the word frequencies of all the first target fields corresponding to the second target field as a word frequency of the second target field; and
when the word frequency of the second target field is greater than a preset word frequency, taking an enterprise corresponding to the second target field as the first target enterprise.

In an optional embodiment, the determining the activation degree of the first target enterprise, includes:
acquiring activation degree index data of the first target enterprise in at least one dimension;
determining an activation degree of the activation degree index data in the dimension for the activation degree index data in each dimension; and
performing weighted average on the activation degree of the activation degree index data in the at least one dimension to determine the activation degree of the first target enterprise.

In an optional embodiment, the determining the activation degree of the activation degree index data in the dimension for the activation degree index data in each dimension, includes:
for the activation degree index data in each dimension, when the activation degree index data in the dimension belongs to a numeric type, determining the activation degree of the activation degree index data in the dimension according to the size of the activation degree index data in the dimension; and
when the activation degree index data in the dimension belongs to a non-numeric type, determining the activation degree of the activation degree index data in the dimension according to existence of the activation degree index data in the dimension.

In a second aspect, the present disclosure provides an apparatus for screening enterprises in Yangtze River Basin, including:
a common enterprise data determining module configured for acquiring original enterprise data belonging to a preset industry category, and comparing the original enterprise data with screened local enterprise data to obtain common enterprise data of the original enterprise data and the local enterprise data;
a text feature extracting module configured for extracting a first text feature from a business scope of the common enterprise data, and extracting a second text feature from a business scope of each enterprise in the original enterprise data; and
a first target enterprise determining module configured for performing feature matching on the second text feature corresponding to each enterprise and the first text feature respectively, and when a matching result meets a preset condition, determining that the enterprise is a first target enterprise.

In an optional embodiment, the apparatus further includes:
an activation degree determining module configured for determining an activation degree of the first target enterprise; and
a second target enterprise determining module configured for screening a second target enterprise from the first target enterprise based on the activation degree.

In an optional embodiment, the text feature extracting module is specifically configured for extracting at least one first target field from the business scope of the common enterprise data, and counting a word frequency of the at least one first target field; and taking a mapping relationship between the first target field and the word frequency as the first text feature; and
for each enterprise in the original enterprise data, extracting at least one second target field from a business scope of the enterprise, and taking the second target field as the second text feature corresponding to the enterprise.

In an optional embodiment, the first target field and the second target field include a business mode field and a business content field.

In an optional embodiment, the first target enterprise determining module is specifically configured for calculating a similarity between the second target field in the second text feature corresponding to each enterprise and each first target field in the first text feature; for each second target field, determining the first target field having the similarity with the second target field greater than a preset similarity threshold as the first target field corresponding to the second target field; taking a sum of the word frequencies of all the first target fields corresponding to the second target field as a word frequency of the second target field; and when the word frequency of the second target field is greater than a preset word frequency, taking an enterprise corresponding to the second target field as the first target enterprise.

In an optional embodiment, the activation degree determining module is specifically configured for acquiring activation degree index data of the first target enterprise in at least one dimension; determining an activation degree of the activation degree index data in the dimension for the activation degree index data in each dimension; and performing weighted average on the activation degree of the activation degree index data in the at least one dimension to determine the activation degree of the first target enterprise.

In an optional embodiment, the activation degree determining module determines the activation degree of the activation degree index data in the dimension for the activation degree index data in each dimension through the following way:
for the activation degree index data in each dimension, when the activation degree index data in the dimension belongs to a numeric type, determining the activation degree of the activation degree index data in the dimension according to a size of the activation degree index data in the dimension; and
when the activation degree index data in the dimension belongs to a non-numeric type, determining the activation degree of the activation degree index data in the dimension according to existence of the activation degree index data in the dimension.

In a third aspect, the present disclosure provides an electronic device, including: a processor, where the processor is configured for executing a computer program stored in a memory, and the computer program, when executed by the processor, implements the method according to the first aspect.

In a fourth aspect, the present disclosure provides a computer-readable storage medium storing a computer program thereon, where the computer program, when executed by a processor, implements the method according to the first aspect.

In a fifth aspect, the present disclosure provides a computer program product, where the computer program product, when running on a computer, enables the computer to execute the method according to the first aspect.

### (III) Beneficial Effects

Compared with the prior art, the technical solutions provided by the embodiments of the present disclosure have the following advantages.

The original enterprise data is acquired according to the preset industry category, and the original enterprise data is compared with the screened local enterprise data to obtain the common enterprise data. The common enterprise data may be considered as the enterprises that have been confirmed in the local enterprise data and have been retained to this day. Further, text analysis is performed on the business scope of the common enterprise data to extract the first text feature as a reference feature, and match the second text feature corresponding to each enterprise with the first text feature to screen the first target enterprise, so that an accuracy of screening the first target enterprise can be improved. Therefore, the supervision efficiency of the environmental protection supervisors can be improved, and the labor costs can be saved.

### BRIEF DESCRIPTION OF THE DRAWINGS

The accompanying drawings herein are incorporated into the specification and constitute a part of the specification, show the embodiments consistent with the present disclosure, and serve to explain the principles of the present disclosure together with the specification.

In order to illustrate the technical solutions in the embodiments of the present disclosure or the prior art more clearly, the drawings to be used in the description of the embodiments or the prior art will be briefly described below. Obviously, those of ordinary skills in the art can also obtain other drawings based on these drawings without going through any creative work.

FIG. 1 is a flow chart of a method for screening enterprises in Yangtze River Basin according to the embodiments of the present disclosure;

FIG. 2 is a schematic diagram of the method for screening enterprises in Yangtze River Basin according to the embodiments of the present disclosure;

FIG. 3 is another flow chart of the method for screening enterprises in Yangtze River Basin according to the embodiments of the present disclosure;

FIG. 4 is a schematic structural diagram of an apparatus for screening enterprises in Yangtze River Basin according to the embodiments of the present disclosure; and

FIG. 5 is a schematic structural diagram of an electronic device according to the embodiments of the present disclosure.

### DETAILED DESCRIPTION OF THE EMBODIMENTS

In order to better understand the above objects, features and advantages of the present disclosure, the solutions of the present disclosure will be further described below. It should be noted that, in case of no conflict, the embodiments in the present disclosure and the features in the embodiments may be mutually combined with each other.

In the following description, many specific details are set forth in order to fully understand the present disclosure, but the present disclosure may be implemented in other ways different from those described herein. Obviously, the embodiments described in the specification are merely a part of, rather than all of, the embodiments of the present disclosure.

There are a large number of “three-phosphorus” enterprises in Yangtze River Economic Belt. Because the list of enterprises obtained by environmental protection supervisors is lagging behind, the list of enterprises used for supervision is incomplete and inaccurate, which undoubtedly brings great pressure to the supervision work of “three-phosphorus” enterprises in Yangtze River Basin.

In order to solve the above problems, the present disclosure provides a method and apparatus for screening enterprises in Yangtze River Basin, an electronic device and a storage medium so as to improve an accuracy of enterprise screening, enhance a supervision efficiency and object targeting, and save the labor cost, which are of great significance for realizing accurate identification of the “three phosphorus” enterprises in Yangtze River Basin.

Referring to FIG. 1, FIG. 1 is a flow chart of a method for screening enterprises in Yangtze River Basin in the embodiments of the present disclosure, where the method may include the following steps.

Step S110: acquiring original enterprise data belonging to a preset industry category, and comparing the original enterprise data with screened local enterprise data to obtain common enterprise data of the original enterprise data and the local enterprise data.

In the embodiments of the present disclosure, the latest original enterprise data may be acquired from the Internet in order to improve timeliness of the list of the supervised enterprises. The preset industry category is an industry category to be supervised, may be an industry category confirmed by experts, and may be set according to actual requirements, for example, may be a national economy industry category of a “phosphorus”-related enterprise, and the like. The original enterprise data includes enterprise information of a plurality of enterprises, and each enterprise may include: company name, unified social credit code, registration number, body name, body type, body status, date of establishment, registered capital currency, registered capital, industry category, industry type, location, business scope, business address, number of people, and the like.

There may also be errors in the original enterprise data. Optionally, data quality may be audited. That is, the original enterprise data may be cleaned. The information error mainly exists in the company name, and there are invalid texts such as brackets, numerals, English words and symbols in the company name field. The text in the company name field may be structured by a text processing technology, and invalid texts such as brackets, numerals, English words and symbols may be deleted. It may be understood that if invalid texts exist in other fields, the invalid texts may be deleted in the same manner.

The local enterprise data may be data recognized by experts by environmental protection supervisors. By comparing the original enterprise data with the local enterprise data, the common data of the two may be obtained, that is, the common enterprise data. As both the original enterprise data and the local enterprise data are data in an enterprise dimension, the company name fields may be directly compared when comparing. For example, the original enterprise data includes enterprise information of enterprises B, C, D and F, while the local enterprise data includes the enterprise information of the enterprises A, B and C. Then, the common enterprise data is the enterprise data of the enterprises B and C. The enterprise A is a previously existing enterprise, which has been cancelled now, and the enterprises D and F are newly registered enterprises. It can be seen that the common enterprise data may be considered as the enterprises that have been confirmed in the local enterprise data and have been retained to this day. As there may be a situation of different company names which refer to the same one enterprise in the common enterprise data, the data may be de-duplicated to reduce a data processing capacity.

Step S120: extracting a first text feature from a business scope of the common enterprise data, and extracting a second text feature from a business scope of each enterprise in the original enterprise data.

It should be noted that the needs of accurate screening of enterprises cannot be met by the preset industry category only, while whether an enterprise is an enterprise to be screened can be accurately determined according to a business scope of the enterprise. Therefore, text analysis may be made on the business scopes of the enterprises to further screen more accurate enterprises. Specifically, text analysis may be performed on the business scope of the common enterprise data to extract the first text feature by technologies such as segmenting, part-of-speech judging, and the like. Similarly, for the original enterprise data, the enterprise data of each enterprise therein may be acquired to respectively extract a second text feature of a business scope of each enterprise in the enterprise data. It can be seen that the first text feature is a feature extracted based on all the common enterprise data, and the second text feature is a text feature corresponding to each enterprise. In this way, the target enterprise may be selected from the original enterprise data by comparing the first text feature and the second text feature with the first text feature as a reference.

Step S130: performing feature matching on the second text feature corresponding to each enterprise and the first text feature respectively, and when a matching result meets a preset condition, determining that the enterprise is a first target enterprise.

For the second text features corresponding to each enterprise, the second text features may be matched with the first text feature. When a matching result meets a matching condition, the enterprise may be considered as an enterprise to be screened, and the enterprise may be regarded as the first target enterprise. When the matching result doesn't meet the matching condition, it may be considered that the enterprise is not an enterprise to be screened, so the enterprise is filtered.

Both the second text feature and the first text feature may contain business contents, and the business contents of the two may be matched. When there are same business contents, it may be considered as that the matching condition is met; and when there are no same business contents, it may be considered as that the matching condition is not met. Certainly, the way of matching the second text feature with the first text feature is not limited to this.

The method for screening enterprises in Yangtze River Basin according to the embodiments of the present disclosure may acquire the original enterprise data according to the preset industry category, and compare the original enterprise data with the screened local enterprise data to obtain the common enterprise data. The common enterprise data may be considered as the enterprises that have been confirmed in the local enterprise data and have been retained to this day. Further, text analysis is performed on the business scope of the common enterprise data to extract the first text feature as a reference feature, and match the second text feature corresponding to each enterprise with the first text feature to screen the first target enterprise, so that an accuracy of screening the first target enterprise can be improved. For example, in the case of screening “phosphorus”-related enterprises, “phosphorus”-related original enterprise data is acquired from the Internet, and the original enterprise data is compared with “phosphorus”-related local enterprise data confirmed by experts, so as to obtain the common enterprise data. The “phosphorus”-related first text feature is extracted from the business scope of the common enterprise data. By extracting the second text feature from the business scope of each enterprise in the original enterprise data and matching the second text feature with the first text feature, the “phosphorus”-related enterprises can be matched, and the accuracy of enterprise screening can be improved, that is, the targeting of the supervised targets can be improved, and the labor cost is saved.

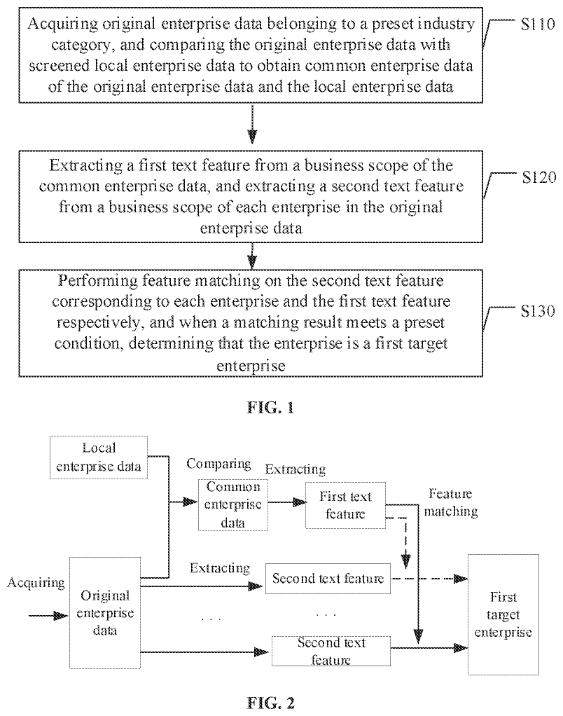

Referring to FIG. 2, FIG. 2 is a schematic diagram of the method for screening enterprises in Yangtze River Basin corresponding to the embodiment of FIG. 1. First, the original enterprise data may be acquired from the Internet according to the industry category of the enterprise to be screened, and the original enterprise data is compared with the local enterprise data to obtain the common enterprise data. The local enterprise data may be an enterprise confirmed by experts, i.e., is in conformity with an industry type of the enterprise to be screened. The common enterprise data refers to the enterprises that have been confirmed in the local enterprise data and have been retained to this day.

By performing the text analysis on the common enterprise data, the first text feature of the business scope is extracted, and the first text feature is a feature representing the common enterprise data. Similarly, the original enterprise data may be taken as a dimension of enterprise, and the second text feature may be extracted from the business scope of each enterprise. Feature matching is performed on the second text feature corresponding to each enterprise and the first text feature to confirm whether the enterprise is the first target enterprise.

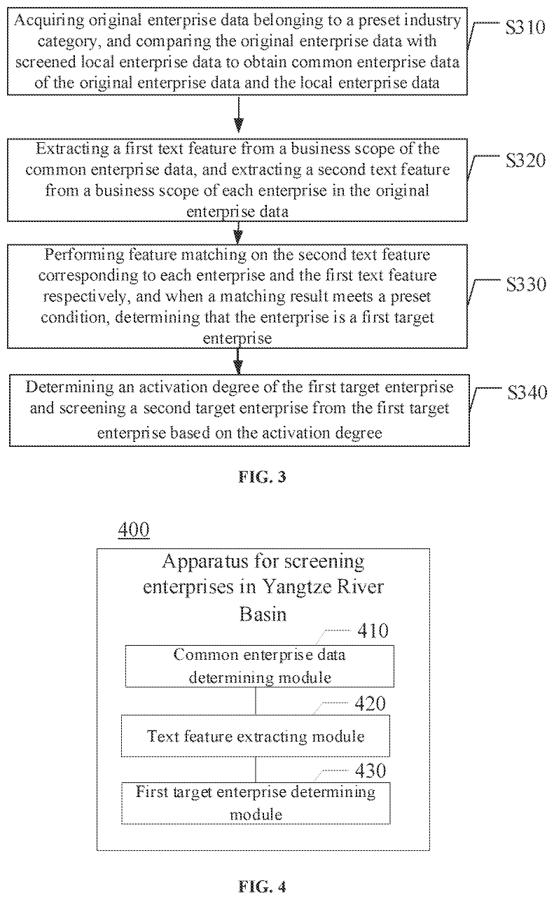

Referring to FIG. 3, FIG. 3 is another flow chart of a method for screening enterprises in Yangtze River Basin in the embodiments of the present disclosure, where the method may include the following steps:

Step S310: acquiring original enterprise data belonging to a preset industry category, and comparing the original enterprise data with screened local enterprise data to obtain common enterprise data of the original enterprise data and the local enterprise data.

This step is the same as step S110 in the embodiment of FIG. 1. Please refer to the description in the embodiment of FIG. 1 for details, which will not be repeated here.

Step S320: extracting a first text feature from a business scope of the common enterprise data, and extracting a second text feature from a business scope of each enterprise in the original enterprise data.

Since the business scope is usually composed of short words, the first text feature extracted in the embodiments of the present disclosure may be a field in the business scope, which is a field related to the preset industry category. Optionally, at least one first target field may be extracted from the business scope of the common enterprise data. For example, the business scope of the “phosphorus”-related enterprise may typically include business content fields such as organic fertilizer, compound fertilizer, and the like. The first target field may be business content fields, for example, may include “organic fertilizer”, “compound fertilizer”, and the like.

The business scope of the enterprise typically belongs to a mode of “action+object”. For example, when the business scope is producing organic fertilizer, then the production belongs to the business mode field and the organic fertilizer belongs to the business content field. Therefore, the first target field may include: the business mode field and the business content field. The first target field extracted from the business scope above is “producing organic fertilizer”.

After that, a word frequency of the at least one first target field is counted, and a mapping relationship between the first target field and the word frequency is taken as the first text feature. Referring to Table 1, Table 1 shows the mapping relationship between the first target field and the word frequency.

TABLE 1

| First target field | Word frequency |
|---|---|
| Production + organic fertilizer \| phosphorus chemical | n1 |
| product | |
| R&D + compound fertilizer | n2 |
| Production + water soluble fertilizer | n3 |
| . . . | . . . |

For each enterprise in the original enterprise data, at least one second target field is extracted from a business scope of the enterprise, and the second target field is taken as the second text feature corresponding to the enterprise. Similarly, the second target field may be business content fields, or may include: the business mode field and the business content field.

Step S330: performing feature matching on the second text feature corresponding to each enterprise and the first text feature respectively, and when a matching result meets a preset condition, determining that the enterprise is a first target enterprise.

In the embodiments of the present disclosure, a similarity between the second target field in the second text feature corresponding to each enterprise and each first target field in the first text feature may be calculated. For each second target field, the first target field having the similarity with the second target field greater than a preset similarity threshold is determined as the first target field corresponding to the second target field. That is, the first target field having the higher similarity with the second target field is selected from the first target field, and a sum of the word frequencies of all the first target fields corresponding to the second target field is taken as a word frequency of the second target field.

TABLE 2

| Enterprise name | Business scope | Word frequency |
|---|---|---|
| Enterprise A | Production + organic fertilizer \| phosphorus chemical | n1 + n2 |
| | product; R&D + compound fertilizer | |
| Enterprise B | Production + water soluble fertilizer | n3 |
| . . . | . . . | . . . |

As shown in Table 2, tor the enterprise A, when the business scope includes two second target fields: production+organic fertilizer|phosphorus chemical product and R&D+compound fertilizer. For each second target field, the matched first target field may be screened out from the first target field, that is, production+organic fertilizer|phosphorus chemical product and R&D+compound fertilizer. The word frequency corresponding to production+organic fertilizer|phosphorus chemical product is n1, and the word frequency corresponding to R&D+compound fertilizer is n2. Therefore, the word frequency of the second target field corresponding to the enterprise A is n2. Similarly, the word frequency of the second target field corresponding to the enterprise B is n3.

It may be understood that the higher the word frequency of the second target field corresponding to the enterprise, the more likely the enterprise is to be the enterprise to be screened. When the word frequency of the second target field is greater than a preset word frequency, the enterprise corresponding to the second target field is taken as the first target enterprise. The preset word frequency may be 30, 40, or the like, and will not be limited in the present disclosure.

Step S340: determining an activation degree of the first target enterprise and screening a second target enterprise from the first target enterprise based on the activation degree.

The knowledge of an economic activity level of an enterprise is basically obtained by means of annual reports of the enterprise. The annual report mode cannot satisfy the timeliness demand of environmental protection supervision, and a large amount of zombie enterprises and shell enterprises can cause a large amount of manpower resources to be wasted. In order to further improve the accuracy of the screened enterprises, the activation degree of the first target enterprise can be analyzed, whether the enterprise belongs to a zombie enterprise or a shell enterprise is determined based on the activation degree, and the zombie enterprise and the shell enterprise are deleted from the first target enterprise, so that the second target enterprise is screened out more accurately.

Specifically, activation degree index data of the first target enterprise in at least one dimension may be acquired. For example, the activation degree index data in the following dimensions may be acquired from the Internet: basic data of industry and commerce, and market supervision departments, data of other administrative departments (including tax data), recruitment information, media information, media publicity, website information, purchase transactions, capital operation, and the like.

For the activation degree index data in each dimension, an activation degree of the activation degree index data in the dimension may be determined. The activation degree index data typically includes two types: a numeric type and a non-numeric type. The numeric type indicates a size of the activation degree index data, and a fractional value type may also be considered as a presence or absence type, that is, whether the activation degree index data exists or not. For the activation degree index data in each dimension, when the activation degree index data in the dimension belongs to a numeric type, the activation degree of the activation degree index data in the dimension is determined according to the size of the activation degree index data in the dimension.

For example, if the size of the activation degree index data is 0, 0 may be used as the activation degree of the activation degree index data. If the size of the activation degree index data is greater than 0 and less than a preset upper limit value, a product of a ratio of the size of the activation degree index data to the preset upper limit value and a first preset standard value (for example, 100, or the like) may be used as the activation degree of the activation degree index data. If the size of the activation degree index data is greater than or equal to the preset upper limit value, the first preset standard value may be used as the activation degree of the activation degree index data.

When the activation degree index data in the dimension belongs to a non-numeric type, the activation degree of the activation degree index data in the dimension is determined according to existence of the activation degree index data in the dimension. For example, if the activation degree index data in the dimension exists, a second preset standard value may be used as the activation degree of the activation degree index data; if the activation degree index data in the dimension does not exist, 0 may be used as the activation degree of the activation degree index data.

After that, weighted average is performed on the activation degree of the activation degree index data in the at least one dimension to determine the activation degree of the first target enterprise. Weights of the activation degree index data in each dimension may be obtained by expert scoring. Certainly, in the activation degree evaluation process, the above weights may also be adjusted according to the actual situation. In addition, the activation degree index data in each dimension may be further subdivided into a plurality of dimensions, and the corresponding weight is set for each dimension to improve an accuracy of determining the activation degree.

It may be understood that if the activation degree of the first target enterprise calculated consequently is 0, it is indicated that the first target enterprise is already cancelled. If the activation degree of the first target enterprise is not 0, it is indicated that the first target enterprise is not cancelled. In the embodiments of the present disclosure, a plurality of activation degree levels (for example, high activation degree level, medium activation degree and low activation degree) may be set according to the activation degree of each first target enterprise, and the first target enterprises are divided into different levels, so that the enterprises with different activation degrees can be subsequently analyzed. Different activation degree levels correspond to different activation degree scopes.

The lower the activation degree of the first target enterprise, the more likely the first target enterprise is to be a zombie enterprise or a shell enterprise. Therefore, the first target enterprise with the activation degree higher than a preset activation degree can be taken as the second target enterprise, or the corresponding activation degrees of the first target enterprises may be sorted from big to small, and the first target enterprises corresponding to the first N activation degrees can be taken as the second target enterprises, where N is a positive integer less than a total number of the first target enterprises.

The method for screening enterprises in Yangtze River Basin of the embodiments of the present disclosure may extract the first text feature from the business scope of the common enterprise data according to a manner of the business mode field plus the business content field, and extract the second text feature from the business scope of each enterprise in the original enterprise data, and can screen the first target enterprise more exactly according to the text analysis manner. After that, the activation degree of the first target enterprise may be further analyzed to grasp a status of the enterprise from all directions, eliminate the zombie enterprises and the shell enterprises from the first target enterprise, improve an accuracy of the final selected second target enterprise, and then improve a targeting ability of supervision by environmental protection supervisors, thus saving labor costs.

Corresponding to the above method embodiments, the embodiments of the present disclosure also provide an apparatus for screening enterprises in Yangtze River Basin. Referring to FIG. 4, the apparatus for screening enterprises in Yangtze River Basin 400 includes:
a common enterprise data determining module 410 configured for acquiring original enterprise data belonging to a preset industry category, and comparing the original enterprise data with screened local enterprise data to obtain common enterprise data of the original enterprise data and the local enterprise data;
a text feature extracting module 420 configured for extracting a first text feature from a business scope of the common enterprise data, and extracting a second text feature from a business scope of each enterprise in the original enterprise data; and
a first target enterprise determining module 430 configured for performing feature matching on the second text feature corresponding to each enterprise and the first text feature respectively, and when a matching result meets a preset condition, determining that the enterprise is a first target enterprise.

In an optional embodiment, the above-mentioned enterprise screening apparatus further includes:
an activation degree determining module configured for determining an activation degree of the first target enterprise; and
a second target enterprise determining module configured for screening a second target enterprise from the first target enterprise based on the activation degree.

In an optional embodiment, the text feature extracting module is specifically configured for extracting at least one first target field from the business scope of the common enterprise data, and counting a word frequency of the at least one first target field; and taking a mapping relationship between the first target field and the word frequency as the first text feature; and
for each enterprise in the original enterprise data, extracting at least one second target field from a business scope of the enterprise, and taking the second target field as the second text feature corresponding to the enterprise.

In an optional embodiment, the first target field and the second target field include a business mode field and a business content field.

In an optional embodiment, the first target enterprise determining module is specifically configured for calculating a similarity between the second target field in the second text feature corresponding to each enterprise and each first target field in the first text feature; for each second target field, determining the first target field having the similarity with the second target field greater than a preset similarity threshold as the first target field corresponding to the second target field; taking a sum of the word frequencies of all the first target fields corresponding to the second target field as a word frequency of the second target field; and when the word frequency of the second target field is greater than a preset word frequency, taking an enterprise corresponding to the second target field as the first target enterprise.

In an optional embodiment, the activation degree determining module is specifically configured for acquiring activation degree index data of the first target enterprise in at least one dimension; determining an activation degree of the activation degree index data in the dimension for the activation degree index data in each dimension; and performing weighted average on the activation degree of the activation degree index data in the at least one dimension to determine the activation degree of the first target enterprise.

In an optional embodiment, the activation degree determining module determines the activation degree of the activation degree index data in the dimension for the activation degree index data in each dimension through the following way:
for the activation degree index data in each dimension, when the activation degree index data in the dimension belongs to a numeric type, determining the activation degree of the activation degree index data in the dimension according to a size of the activation degree index data in the dimension; and
when the activation degree index data in the dimension belongs to a non-numeric type, determining the activation degree of the activation degree index data in the dimension according to existence of the activation degree index data in the dimension.

The specific details of each module or unit in the apparatus above have been described in detail in the corresponding method, and therefore will not be elaborated herein.

It should be noted that while a plurality of modules or units of the device for action execution have been mentioned in the detailed description above, this division is not mandatory. In fact, according to the embodiments of the present disclosure, the features and functions of the two or more modules or units described above may be embodied in one module or unit. On the contrary, the features and functions of one module or unit described above can be further divided into being embodied by more modules or units.

An exemplary embodiment of the present disclosure also provides an electronic device, including: a processor; and a memory for storing instructions executable by the processor; where, the processor is configured for executing the method for screening enterprises in Yangtze River Basin in the exemplary embodiment.

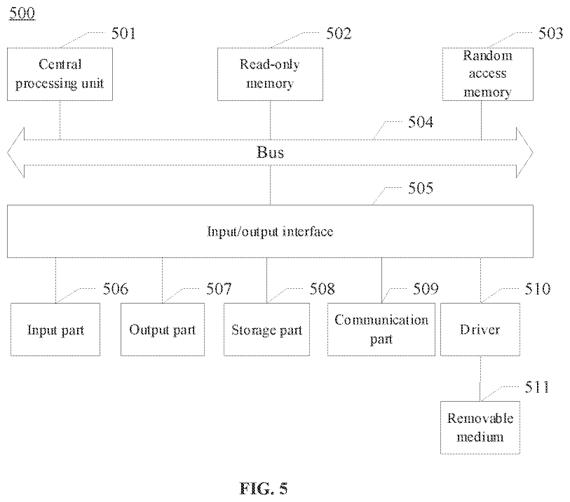

FIG. 5 is a schematic structural diagram of an electronic device according to the embodiments of the present disclosure. It should be noted that the electronic device 500 shown in FIG. 5 is merely an example and should not impose any limitation on the function and scope of use of the embodiments of the present disclosure.

As shown in the FIG. 5, the electronic device 500 includes a central processing unit (CPU) 501, which can perform various appropriate actions and processes according to a program stored in a read-only memory (ROM) 502 or loaded from a storage part 508 into a random access memory (RAM) 503. In the RAM 503, various programs and data needed for system operating may also be stored. The CPU 501, the ROM 502, and the RAM 503 are connected to each other through a bus 504. An input/output (I/O) interface 505 is also connected to the bus 504.

The following components are connected to the I/O interface 505: an input part 506, such as a keyboard, a mouse, and the like; an output part 507 including, for example, a cathode ray tube (CRT), a liquid crystal display (LCD), a loud speaker and the like; a storage part 508 including a hard disk and the like; and a communication part 509 including a network interface card such as a local area network (LAN) card, a modem and the like. The communication part 509 performs communication processing via a network such as the Internet. A driver 510 is also connected to the I/O interface 505 as needed. A removable medium 511, such as a magnetic disk, an optical disk, a magneto-optical disk, a semiconductor memory, and the like, is installed on the driver 510 as needed, so that a computer program read therefrom can be installed into the storage part 508 as needed.

Particularly, according to the embodiments of the present disclosure, the process described above with reference to the flow chart can be implemented as a computer software program. For example, the embodiments of the present disclosure include a computer program product, which includes a computer program carried on a computer-readable medium, and the computer program contains a program code for executing the method shown in the flow chart. In such embodiments, the computer program may be downloaded and installed from the network through the communication part 509, and/or installed from the removable medium 511. When the computer program is executed by the central processing unit (CPU) 501, various functions defined in the apparatus of the present disclosure are executed.

The embodiments of the present disclosure further provide a computer-readable storage medium storing a computer program thereon, where the computer program, when executed by a processor, performs the method for screening enterprises in Yangtze River Basin above.

It should be noted that the computer-readable storage medium shown in the present disclosure may be, for example, but is not limited to, an electronic, magnetic, optical, electromagnetic, infrared, or semiconductor system, apparatus, or device, or any combination of the above. More specific examples of the computer-readable storage medium may include, but are not limited to, an electrical connection with one or more wires, a portable computer disk, a hard disk, a random access memory, a read-only memory (ROM), an erasable programmable read only memory (EPROM or flash), an optical fiber, a portable compact disk read-only memory (CD-ROM), an optical memory device, a magnetic memory device, or any suitable combination of the above. In comp the present disclosure, the computer-readable storage medium may be any tangible medium containing or storing a program that may be used by or in connection with an instruction execution system, apparatus, or device. The program code contained on the computer-readable storage medium may be transmitted by any suitable medium, including but not limited to wireless, electric wire, optical cable, radio frequency, and the like, or any suitable combination of the above.

The embodiments of the present disclosure further provide a computer program product that, when running on a computer, causes the computer to perform the method for screening enterprises in Yangtze River Basin above.

It should be noted that relational terms herein such as “first” and “second” and the like, are used merely to distinguish one entity or operation from another entity or operation, and do not necessarily require or imply there is any such relationship or order between these entities or operations. Furthermore, the terms “including”, “comprising” or any variations thereof are intended to embrace a non-exclusive inclusion, such that a process, method, article, or device including a plurality of elements includes not only those elements but also includes other elements not expressly listed, or also incudes elements inherent to such a process, method, article, or device. In the absence of further limitation, an element defined by the phrase “including a . . . ” does not exclude the presence of additional identical element in the process, method, article, or device.

The above are only specific embodiments of the present disclosure, so that those skilled in the art can understand or realize the present disclosure. Many modifications to these embodiments will be obvious to those skilled in the art, and the general principles defined herein can be implemented in other embodiments without departing from the spirit or scope of the present disclosure. Therefore, the present disclosure will not to be limited to these embodiments shown herein, but is to be in conformity with the widest scope consistent with the principles and novel features disclosed herein.

### INDUSTRIAL APPLICABILITY

The method for screening enterprises in Yangtze River Basin provided by the embodiments of the present disclosure acquires the original enterprise data according to the preset industry category, and compares the original enterprise data with the screened local enterprise data to obtain the common enterprise data. The common enterprise data may be considered as the enterprises that have been confirmed in the local enterprise data and have been retained to this day. Further, text analysis is performed on the business scope of the common enterprise data to extract the first text feature as the reference feature, and match the second text feature corresponding to each enterprise with the first text feature to screen the first target enterprise, so that the accuracy of screening the first target enterprise can be improved. Therefore, the supervision efficiency of the environmental protection supervisors can be improved, and the labor costs can be saved.

What is claimed is:

1. A method for screening enterprises in Yangtze River Basin, wherein the method comprises:
acquiring original enterprise data belonging to a preset industry category, and comparing the original enterprise data with screened local enterprise data to obtain common enterprise data of the original enterprise data and the local enterprise data;
extracting a first text feature from a business scope of the common enterprise data, and extracting a second text feature from a business scope of each enterprise in the original enterprise data; and
performing a feature matching on the second text feature corresponding to each enterprise and the first text feature respectively, and when a matching result meets a preset condition, determining that the enterprise is a first target enterprise.

2. The method according to claim 1, wherein after determining that the enterprise is the first target enterprise, the method further comprises:
determining an activation degree of the first target enterprise and screening a second target enterprise from the first target enterprise based on the activation degree.

3. The method according to claim 1, wherein the step of extracting the first text feature from the business scope of the common enterprise data comprises:
extracting at least one first target field from the business scope of the common enterprise data, and counting a word frequency of the at least one first target field; and
taking a mapping relationship between the at least one first target field and the word frequency as the first text feature; and
the step of extracting the second text feature from the business scope of each enterprise in the original enterprise data comprises:
for each enterprise in the original enterprise data, extracting at least one second target field from a business scope of the enterprise; and
taking the at least one second target field as the second text feature corresponding to the enterprise.

4. The method according to claim 3, wherein the first target field and the second target field comprise a business mode field and a business content field.

5. The method according to claim 3, wherein the step of performing the feature matching on the second text feature corresponding to each enterprise and the first text feature respectively, and when the matching result meets the preset condition, determining that the enterprise is the first target enterprise comprises:
calculating a similarity between the second target field in the second text feature corresponding to each enterprise and each first target field in the first text feature;
for each second target field, determining the first target field having the similarity with the second target field greater than a preset similarity threshold as the first target field corresponding to the second target field;
taking a sum of the word frequencies of all the first target fields corresponding to the second target field as a word frequency of the second target field; and
when the word frequency of the second target field is greater than a preset word frequency, taking an enterprise corresponding to the second target field as the first target enterprise.

6. The method according to claim 2, wherein the step of determining the activation degree of the first target enterprise comprises:
acquiring activation degree index data of the first target enterprise in at least one dimension;
determining an activation degree of the activation degree index data in the dimension for the activation degree index data in each dimension; and
performing a weighted average on the activation degree of the activation degree index data in the at least one dimension to determine the activation degree of the first target enterprise.

7. The method according to claim 6, wherein the step of determining the activation degree of the activation degree index data in the dimension for the activation degree index data in each dimension comprises:
for the activation degree index data in each dimension, when the activation degree index data in the dimension belongs to a numeric type, determining the activation degree of the activation degree index data in the dimension according to a size of the activation degree index data in the dimension; and
when the activation degree index data in the dimension belongs to a non-numeric type, determining the activation degree of the activation degree index data in the dimension according to an existence of the activation degree index data in the dimension.

8. An apparatus for screening enterprises in Yangtze River Basin, wherein the apparatus comprises:
a common enterprise data determining module, wherein the common enterprise data determining module is configured for acquiring original enterprise data belonging to a preset industry category and comparing the original enterprise data with screened local enterprise data to obtain common enterprise data of the original enterprise data and the local enterprise data;
a text feature extracting module, wherein the text feature extracting module is configured for extracting a first text feature from a business scope of the common enterprise data and extracting a second text feature from a business scope of each enterprise in the original enterprise data; and
a first target enterprise determining module, wherein the first target enterprise determining module is configured for performing a feature matching on the second text feature corresponding to each enterprise and the first text feature respectively and determining that the enterprise is a first target enterprise when a matching result meets a preset condition.

9. An electronic device, comprising: a processor, wherein the processor is configured for executing a computer program stored in a memory, and the computer program, when executed by the processor, implements the steps of the method according to claim 1.

10. A computer-readable storage medium storing a computer program thereon, wherein the computer program, when executed by a processor, implements the steps of the method according to claim 1.

11. The method according to claim 2, wherein the extracting the first text feature from the business scope of the common enterprise data, comprises:
extracting at least one first target field from the business scope of the common enterprise data, and counting a word frequency of the at least one first target field; and
taking a mapping relationship between the at least one first target field and the word frequency as the first text feature; and
the step of extracting the second text feature from the business scope of each enterprise in the original enterprise data comprises:
for each enterprise in the original enterprise data, extracting at least one second target field from a business scope of the enterprise; and
taking the at least one second target field as the second text feature corresponding to the enterprise.

12. The electronic device according to claim 9, wherein in the method, after determining that the enterprise is the first target enterprise, the method further comprises:
determining an activation degree of the first target enterprise and screening a second target enterprise from the first target enterprise based on the activation degree.

13. The electronic device according to claim 9, wherein in the method, the step of extracting the first text feature from the business scope of the common enterprise data comprises:
extracting at least one first target field from the business scope of the common enterprise data, and counting a word frequency of the at least one first target field; and
taking a mapping relationship between the at least one first target field and the word frequency as the first text feature; and
the step of extracting the second text feature from the business scope of each enterprise in the original enterprise data comprises:
for each enterprise in the original enterprise data, extracting at least one second target field from a business scope of the enterprise; and
taking the at least one second target field as the second text feature corresponding to the enterprise.

14. The electronic device according to claim 13, wherein in the method, the first target field and the second target field comprise a business mode field and a business content field.

15. The electronic device according to claim 13, wherein in the method, the step of performing the feature matching on the second text feature corresponding to each enterprise and the first text feature respectively, and when the matching result meets the preset condition, determining that the enterprise is the first target enterprise comprises:
calculating a similarity between the second target field in the second text feature corresponding to each enterprise and each first target field in the first text feature;
for each second target field, determining the first target field having the similarity with the second target field greater than a preset similarity threshold as the first target field corresponding to the second target field;
taking a sum of the word frequencies of all the first target fields corresponding to the second target field as a word frequency of the second target field; and
when the word frequency of the second target field is greater than a preset word frequency, taking an enterprise corresponding to the second target field as the first target enterprise.

16. The electronic device according to claim 12, wherein in the method, the step of determining the activation degree of the first target enterprise comprises:
acquiring activation degree index data of the first target enterprise in at least one dimension;
determining an activation degree of the activation degree index data in the dimension for the activation degree index data in each dimension; and
performing a weighted average on the activation degree of the activation degree index data in the at least one dimension to determine the activation degree of the first target enterprise.

17. The electronic device according to claim 16, wherein in the method, the step of determining the activation degree of the activation degree index data in the dimension for the activation degree index data in each dimension comprises:
for the activation degree index data in each dimension, when the activation degree index data in the dimension belongs to a numeric type, determining the activation degree of the activation degree index data in the dimension according to a size of the activation degree index data in the dimension; and
when the activation degree index data in the dimension belongs to a non-numeric type, determining the activation degree of the activation degree index data in the dimension according to an existence of the activation degree index data in the dimension.

18. The computer-readable storage medium according to claim 10, wherein in the method, after determining that the enterprise is the first target enterprise, the method further comprises:
determining an activation degree of the first target enterprise and screening a second target enterprise from the first target enterprise based on the activation degree.

19. The computer-readable storage medium according to claim 10, wherein in the method, the step of extracting the first text feature from the business scope of the common enterprise data comprises:
extracting at least one first target field from the business scope of the common enterprise data, and counting a word frequency of the at least one first target field; and
taking a mapping relationship between the at least one first target field and the word frequency as the first text feature; and
the step of extracting the second text feature from the business scope of each enterprise in the original enterprise data comprises:
for each enterprise in the original enterprise data, extracting at least one second target field from a business scope of the enterprise; and
taking the at least one second target field as the second text feature corresponding to the enterprise.

20. The computer-readable storage medium according to claim 19, wherein in the method, the first target field and the second target field comprise a business mode field and a business content field.
